(19) United States
(12) Patent Application Publication
(10) Pub. No.: US 2007/0059073 A1
(43) Pub. Date: Mar. 15, 2007

(54) METHOD FOR PRINTING DATA ACCORDING TO SENSING SIGNALS FROM SENSING MODULES

(76) Inventor: Ming-Jyh Sun, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/462,050

(22) Filed: Aug. 3, 2006

(30) Foreign Application Priority Data
Sep. 12, 2005 (TW) 094131281

(51) Int. Cl. B41J 29/38

(52) U.S. Cl. 400/76

(57) ABSTRACT

Dynamically modifying a positioning error during a printing process uses a plurality of sensing modules installed on a feeding path of a printing medium inside a printer. When any of the plurality of sensing modules detects one end of the printing medium, the sensing module transmits a signal to a printing control unit of the printer, where the printing control unit then updates the content to be printed according to positioning data obtained during the first printing process. The printing quality is enhanced by the method, which enables a color printer to transfer dye of different colors from a ribbon onto the printing medium concordantly.

### BACKGROUND OF THE INVENTION

1. Field of the Invention

The present invention relates to a method for printing data, and more specifically, to a method for printing data according to sensing signals from sensing modules.

2. Description of the Prior Art

A thermal photo printer transfers dye from a ribbon onto a printed medium through a thermal print head (TPH). The complexity and richness in color on the printed medium are achieved through the technique of multicolor chromatography. To transfer each color of the ribbon at a correct position of the printed medium precisely, the printed medium must be in the correct orientation.

A traditional way uses a light emitting diode (LED) and a light sensor that form a sensing module for positioning the printed medium. Please refer to FIG. 1, which is an illustration of a prior art thermal photo printer 1 having a sensing module 70 for positioning a piece of paper 60. The printer 1 comprises a TPH 10, a ribbon-feeding bay 30, a ribbon-driving bay 40, a ribbon 20, a platen roller 50, and a sensing module 70. The sensing module 70 comprises a light emitting diode (LED) 80 and a light sensor 90. Being fed in between the platen roller 50 and the TPH 10, the paper 60 first encounters the sensing module 70 and blocks the light emitted from the LED 80. As the paper 60 keeps moving between the platen roller 50 and the TPH 10 until a back end of the paper 60 leaves the sensing module 70, the light emitted from the LED 80 of the sensing module 70 is no longer blocked by the paper 60 and can be received by the light sensor 90. Once the light sensor 90 receives the light emitted from the LED 80, the sensing module 70 transmits a signal to the printer 1. The printer 1 begins to print onto the paper 60 once receiving the signal from the sensing module 70. The location of the paper 60 where the TPH 10 is positioned is a print starting line. In the prior art, one sensing module 70 is used for positioning the print starting line on the paper 60.

However, in completing a full printing process by transferring different colors onto the same piece of paper 60, the printed content of different colors at a same location on the paper 60 may differ due to a variation of tension applied on the ribbon 20 by the ribbon-driving bay 40 of the printer 1. That is because heating of the TPH 10 during printing causes different ribbon tensions and driving forces to affect the paper 60, which directly influences the consistency of color transferring during the printing process.

### SUMMARY OF THE INVENTION

Therefore, the primary objective of the claimed invention is to provide a method for printing data according to a sensing signal from a sensing module to solve the above problem.

The claimed invention provides a method for printing data according to a sensing signal from a sensing module. The method comprises a print head starting a data printing job when a first sensing module detects one end of a printing medium, storing an address of a position of the currently printed data when a second sensing module detects one end of the printing medium while the print head is printing to the printing medium, and the print head printing data according to the stored address when the second sensing module detects the end of the printing medium again while the print head is again printing to the printing medium.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a thermal photo printer having a sensing module for positioning paper according to the prior art.

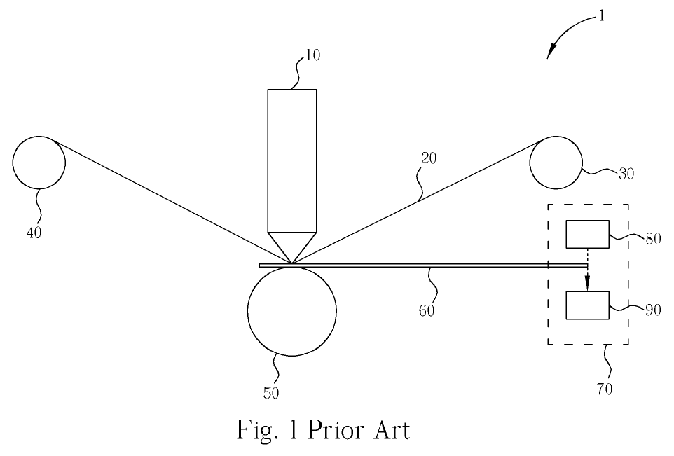

FIG. 2 is a flow chart of a present invention method for printing data according to sensing signals from sensing modules.

FIG. 3 is an illustration of a printer having a plurality of light sensing modules according to the present invention.

FIG. 4 is an illustration of the printer in FIG. 3 when a second sensing module detects the back end of the paper.

FIG. 5 is an illustration of the printer in FIG. 3 when a third sensing module detects the back end of the paper.

FIG. 6 is an illustration of positioning data of paper according to the present invention.

FIG. 7 is another exemplary embodiment of the present invention.

### DETAILED DESCRIPTION

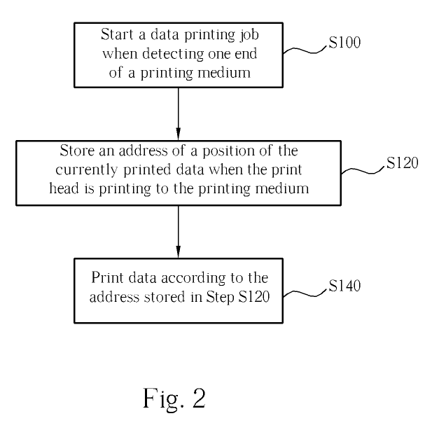

Please refer to FIG. 2, which illustrates a flow chart of the method for printing data according to sensing signals from sensing modules. The method has the following steps:

Step S100: a print head starts a data printing job when a first sensing module detects one end of a printing medium;

Step S120: an address of a position of the currently printed data is stored when a second sensing module detects one end of the printing medium while the print head is printing to the printing medium;

Step S140: the print head prints data according to the address stored in Step S120 when the second sensing module detects the end of the printing medium again while the print head is again printing to the printing medium.

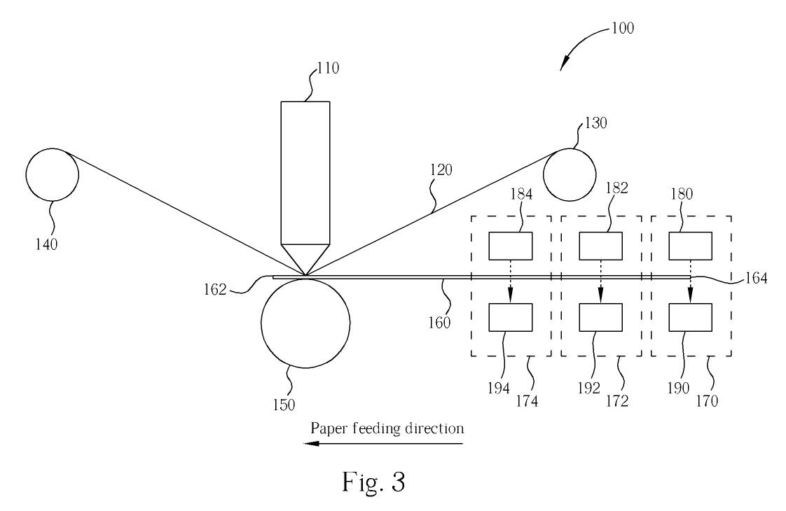

Regarding the present invention and the way to perform the method, please refer to FIG. 3 for a preferred exemplary embodiment. FIG. 3 illustrates a printer 100 having a plurality of light sensing modules 170, 172, and 174. The printer 100 comprises a TPH 110, a ribbon-feeding bay 130, a ribbon-driving bay 140, a ribbon 120, a platen roller 150, a first sensing module 170, a second sensing module 172, and a third sensing module 174. The first sensing module 170 comprises an LED 180 and a light sensor 190, the second sensing module 172 comprises an LED 182 and a light sensor 192, and the third sensing module 174 comprises an LED 184 and a light sensor 194.

The printer 100 serves to repeatedly transfer dye of different color (generally yellow, magenta, or cyan) of the ribbon 120 onto a piece of paper 160, where the three outputs of each color are combined to form a full-color image. The complete printing process is finished when an overcoating is layered onto the paper 160 by the printer 100 during a final process. Assume that yellow is the first color to be printed onto the paper 160. During the first printing process, the paper 160 moves on a feeding path and its front end 162 enters the space between the platen roller 150 and the TPH 110 until the first sensing module 170 detects a back end 164 of the paper 160, and the light emitted from the LED 180 of the first sensing module 170 is no longer blocked by the paper 160 and can be received by the light sensor 190 of the first sensing module 170. Once the light sensor 190 receives the light emitted from the LED 180, the first sensing module 170 transmits a signal to a printing control unit (not shown in the figure) of the printer 100. The printer 100 sets a time point for a printing job when receiving the signal from the first sensing module 170. At this moment, the location at which the TPH 110 contacts the paper 160 is treated as a print starting line on the paper 160 corresponding to the time point set by the printer 100, or in other way, a location where the printer 100 can adjust an offset of the paper 160. The first sensing module 170 is used for positioning the starting point of a printing job since the TPH 110 begins the printing job of the paper 160 at the location of the print starting line right after the printer 100 receives the signal transmitted by the first sensing module 170.

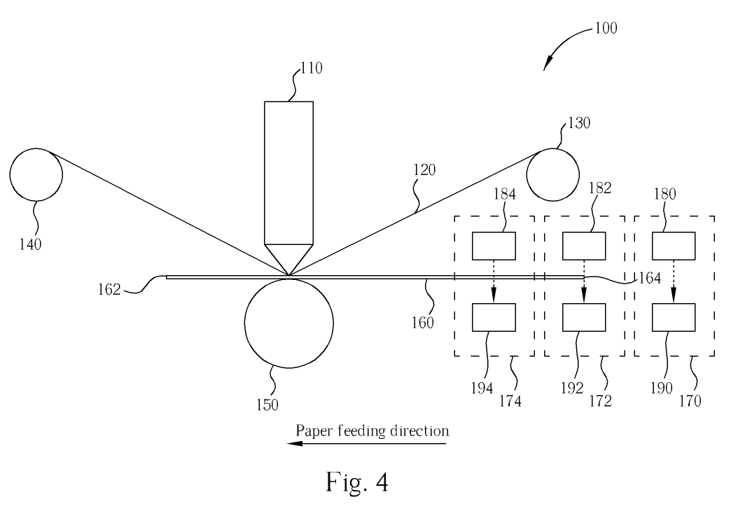

Please refer to FIG. 4 for an illustration of the printer 100 in FIG. 3 when the second sensing module 172 detects a back end 164 of the paper 160. The paper 160 keeps proceeding forward during the first printing process until the second sensing module 172 detects the back end 164 of the paper 160. Just like what happens with the first sensing module 170, the light emitted from the LED 182 of the second sensing module 172 is no longer blocked by the paper 160 and can be received by the light sensor 192 of the second sensing module 172, which then transmits a signal to the printing control unit of the printer 100. The printer 100 then sets another time point and stores the address of a position of the currently printed data (printed by the TPH 110) when receiving the signal from the second sensing module 172.

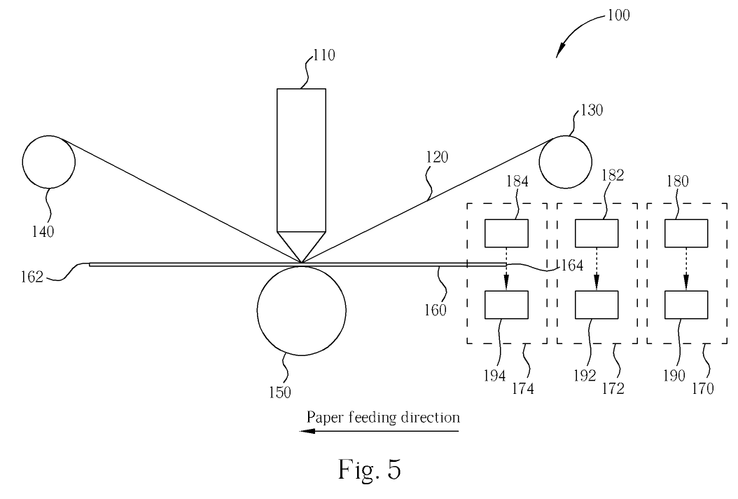

FIG. 5 is an illustration of the printer 100 in FIG. 3 when the third sensing module 174 detects the back end 164 of the paper 160 in the first printing process. Similar to the second sensing module 172 in FIG. 4, the third sensing module 174 transmits a signal to the printing control unit of the printer 100 when detecting the back end 164 of the paper 160. The printer 100 stores another address of a position of the currently printed data (printed by the TPH 110) when receiving the signal from the third sensing module 174.

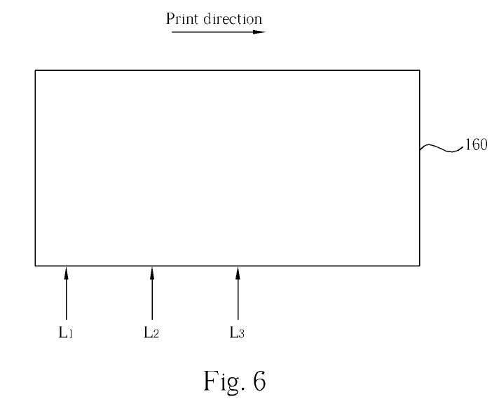

Please refer to FIG. 6. FIG. 6 is an illustration of the paper 160 having positioning data, where the positions L1, L2, and L3 respectively correspond to the positions stored by the printing control unit of the printer 100 when receiving signals from the first sensing module 170, the second sensing module 172, and the third sensing module 174 respectively. L1 is the print starting line, at which the TPH 110 begins to print onto the paper 160.

As FIG. 3 to FIG. 5 show, when in the first printing process (printing yellow color, for example) the three sensing modules 170, 172, and 174 respectively detect the back end 164 of the paper 160, the printer 100 obtains positioning data of L1, L2, and L3 on the paper 160 according to the signals transmitted by each sensing module respectively. During a second printing process (printing magenta color, for example), the first sensing module 170 again detects the back end 164 of the paper 160 (the TPH 110 now is positioned on the location of L1 of the paper 160), and the first sensing module 170 again transmits a signal to the printer 100. The printer 100 begins a second printing job of the second color at the location of L1 so that the print starting line of the second color lies right on the print starting line of the first color.

As mentioned in the description of the prior art, the tension applied on the ribbon 120 and the force that the ribbon drives to the paper 160 may differ with temperature. In addition, friction between the platen roller 150 and the paper 160 may not be constant at different printing processes. Content to be printed onto the paper 160 at locations following the print starting line when printing in the second printing process changes its exact location compared to that in the first printing process. This is the problem of the prior art.

As a result, when the paper 160 goes through the second printing process and moves on until the second sensing module 172 detects the back end 164 of the paper 160 (the TPH 110 is located on L2 of the paper 160 at this point), the method of the present invention compares the data that is currently printed on the paper 160 with the data corresponding to the location L2. If the comparison shows a mismatch, the method can update the printed data with data corresponding to the location L2. Practically, the comparison is not a necessary step since the printer 100 can just update the printed data with data corresponding to the location L2 directly. With the manipulation disclosed above, the positioning error during printing accumulated from starting line L1 to location L2 can then be modified and corrected for better printing output quality than the prior art.

As mentioned before, the printing method of the present invention can provide a third sensing module 174 (fourth, fifth, etc.) for a finer printing correction, wherein the correction works the same as with the second sensing module 172.

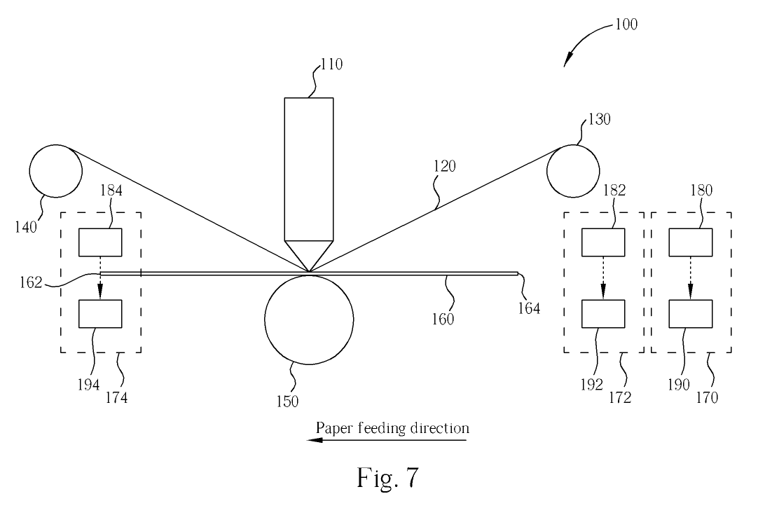

The method of the present invention in FIG. 3 to FIG. 5 is a preferred exemplary embodiment. However, the deployment of the plurality of sensing modules is not to be limited by the preferred exemplary embodiment. FIG. 7 is another exemplary embodiment of the present invention. Different from the first exemplary embodiment, the third sensing module 174 is deployed on the left side of the TPH 110. This means that the front end 162 of the paper 160 keeps moving left when leaving the print head 110; and after the back end 164 leaves the first sensing module 170 and the second sensing module 172 successively, which in this part is the same as the first exemplary embodiment, the third sensing module 174 disposed on the left of the TPH 110 transmits a third sensing signal (compared to the first sensing signal and the second sensing signal transmitted by the first sensing module 170 and the second sensing module 172, respectively) when it detects the front end 162 of the paper 160. The TPH 110 then does the same as when it receives the signals from the first or second sensing module 170 or 172.

Additionally, an arbitrary number and method of deployment of sensing modules can be used in the present invention. With the method for printing data according to a sensing signal from a sensing module, the content to be printed can be dynamically modified to correct position error during a printing process using a plurality of sensing modules installed on a feeding path of a printing medium inside the printer. The present invention can effectively improve the printing quality comparing to the prior art thermal printer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for printing data according to a sensing signal from a sensing module, comprising:
(a) a print head starting a data printing job when a first sensing module detects one end of a printing medium;
(b) storing an address of a position of the currently printed data when a second sensing module detects one end of the printing medium while the print head is printing to the printing medium; and
(c) the print head printing data according to the address stored in step (b) when the second sensing module detects the end of the printing medium again while the print head is again printing to the printing medium.

2. The method of claim 1 wherein the print head starts the data printing job when the first sensing module detects a back end of the printing medium in step (a).

3. The method of claim 1 wherein step (b) stores the address of the position of the currently printed data when the second sensing module detects a front end of the printing medium while the print head is printing to the printing medium.

4. The method of claim 3 wherein the print head prints data according to the address stored in step (b) when the second sensing module detects the front end of the printing medium again while the print head is again printing to the printing medium.

5. The method of claim 1 wherein step (b) stores the address of the position of the currently printed data when the second sensing module detects a back end of the printing medium while the print head is printing to the printing medium.

6. The method of claim 5 wherein the print head prints data according to the address stored in step (b) when the second sensing module detects the back end of the printing medium again while the print head is again printing to the printing medium.

7. The method of claim 1, wherein data is printed according to sensing signals of a plurality of sensing modules.

8. The method of claim 1 wherein step (a) comprises adjusting an offset of the printing medium.
